(19) United States
(12) Patent Application Publication
(10) Pub. No.: US 2025/0093915 A1
(43) Pub. Date: Mar. 20, 2025

(54) MOBILE COMMUNICATION DEVICE PROTECTIVE CASE

(71) Applicant: Dongguan Yuanpu Technology Co., Ltd, Dongguan (CN)

(72) Inventors: Yaxing PENG, Dongguan (CN); Ying CHEN, Dongguan (CN); Wei JIANG, Dongguan (CN)

(21) Appl. No.: 18/964,341

(22) Filed: Nov. 29, 2024

(30) Foreign Application Priority Data
Jan. 16, 2024 (CN) 202420104338.0
Feb. 29, 2024 (CN) 202420379348.5
Mar. 23, 2024 (CN) 202420570453.7
Jun. 17, 2024 (CN) 202421372646.8

(51) Int. Cl. G06F 1/16; G06F 21/32

(52) U.S. Cl. CPC G06F 1/1656; G06F 1/1684; G06F 21/32

(57) ABSTRACT

Disclosed is a mobile communication device protective case, including a housing put on a mobile phone, the housing is provided with a button opening at a position adapted to a touch-sensitive button, the button opening is installed with a membrane; and the membrane includes a fingerprint area located in a center and a fixed area surrounding the fingerprint area, the fixed area is fixedly connected to the housing, the fingerprint area is exposed from the button opening, and an inner side surface of the fingerprint area is connected to the touch-sensitive button located at the button opening, such that a user's finger can be recognized by the touch-sensitive button via the fingerprint area. In the present disclosure, the housing can protect the touch-sensitive buttons through the membrane, and a mute toggle key of the mobile phone can be accurately toggled through a toggle button and a lever.

### CROSS-REFERENCE TO RELATED APPLICATIONS

This application claims the benefit of priority from Chinese Patent Application No. 202421372646.8, filed on Jun. 17, 2024; Chinese Patent Application No. 202420570453.7, filed on Mar. 23, 2024; Chinese Patent Application No. 202420104338.0, filed on Jan. 16, 2024; and Chinese Patent Application No. 202420379348.5, filed on Feb. 29, 2024. The content of the aforementioned applications, including any intervening amendments thereto, is incorporated herein by reference.

### TECHNICAL FIELD

The present disclosure relates to the technical field of mobile phone protection, and particularly relates to a mobile communication device protective case.

### BACKGROUND

Mobile phones, with extensive use, have become increasingly important to people. Many people need to carry their mobile phones in various environments for work and daily life. In order to protect the mobile phones, protective cases are usually put on the mobile phones during use to reduce the damage caused by bumps and impacts. In addition, some protective cases have waterproof functions to improve the waterproof performance of the mobile phones in outdoor activities or humid environments.

However, a protective case will affect the convenience of using a mobile phone while protecting the mobile phone, for example, the protective case will affect operations such as fingerprint unlocking and control by fingerprint touch. At present, many functions of the mobile phone can be realized through a touch screen, and many software operations are integrated into the touch screen. Nevertheless, it is inconvenient to perform some operations via the touch screen. Therefore, physical buttons, such as volume button, lock button, and touch-sensitive buttons, are still kept for separate use. Specifically, the touch-sensitive buttons are divided into side touch-sensitive buttons arranged on a middle frame of the mobile phone, and rear touch-sensitive button arranged on a back panel of the mobile phone. For some mobile phones, the side touch-sensitive buttons can be used to achieve additional quick operations, such as fingerprint unlocking, sliding to control picture zooming while browsing pictures, switching images while browsing pictures, sliding to control a focal length while taking photos, sliding to control a volume, tapping to take photos, and answering calls. Some mobile phones also use the rear touch-sensitive buttons, apart from the side touch-sensitive buttons, to perform the operations. Since both the middle frame and the back panel of the mobile phone need to be protected, the protective case is usually provided with openings where the side or rear touch-sensitive buttons are located, so as to enable the touch-sensitive buttons to be exposed from the openings, such that a user's finger can touch the touch-sensitive buttons. Due to being exposed, the touch-sensitive buttons cannot be protected by the protective case and are easily scratched or bumped, affecting their safe use.

Furthermore, the protective case will affect a mute toggle key function of some mobile phones. The mute toggle key is arranged on a side frame of the mobile phone, which is a position that needs to be protected. In order to not affect the use of the mute toggle key, the protective case is usually provided with an opening where the mute toggle key is located to enable the mute toggle key to be exposed from the opening, such that the user can touch the mute toggle key. Due to being exposed, the mute toggle key is not protected by the protective case and is easily scratched or bumped, making it difficult to maintain a waterproof function.

For example, the Chinese Patent (Application No.: CN201921747610.2) discloses a mobile phone protective case having a mute toggle key, the protective case includes a protective case main body and a toggle member, where the protective case main body is provided with a through hole adapted to a mute button at a position corresponding to the mute button of the mobile phone, the toggle member is movably connected to the through hole of the protective case main body of the mobile phone, and the toggle member is adapted to the mute button. The protective case main body of the mobile phone provided in the patent allows for flexible operation of the mute button while protecting the mute mutton. However, in order to allow the toggle member to be movably installed in the through hole, a gap has to be formed between the toggle member and the through hole, which compromises the waterproofing function of the protective case.

Therefore, it is necessary to improve existing protective cases, such that the touch-sensitive buttons and the mute toggle key of the mobile phone can be flexibly operated while protecting the mobile phone and maintaining the waterproofing function of the mobile phone.

### SUMMARY

In order to solve the defects in the prior art, the present disclosure provides a mobile communication device protective case.

The present disclosure provides a mobile communication device protective case, including a housing put on a mobile phone, the housing is provided with a button opening at a position adapted to a touch-sensitive button, the button opening is installed with a membrane, and the membrane includes a fingerprint area located in a center and a fixed area surrounding the fingerprint area; the fixed area is fixedly connected to the housing, the fingerprint area is exposed from the button opening, and an inner side surface of the fingerprint area is connected to the touch-sensitive button located at the button opening, such that a user's finger can be recognized by the touch-sensitive button via the fingerprint area of the membrane.

Compared with the prior art, the present disclosure has the following beneficial effects: the membrane is arranged at the button opening of the housing, the touch-sensitive buttons are protected to prevent the touch-sensitive buttons from being scratched and achieve a sealing effect at the touch-sensitive buttons of the housing; the mute toggle key of the mobile phone can be accurately toggled through the toggle button and the internal lever, and the waterproof sealing performance of the housing at the mute toggle key can be ensured; at a snap-fitted connection between the middle shell and the back cover, sealing is achieved through a concentric three-ring positioning and snap-fit sealing structure; and the screen membrane and the lens membrane are used on the screen and camera sides, respectively, the waterproof membrane is used at the speaker holes, and the plug is used at the charging port, ensuring the waterproof sealing performance of the entire housing.

### BRIEF DESCRIPTION OF THE DRAWINGS

FIG. 1 is a three-dimensional structural schematic diagram of a mobile communication device protective case according to Example 1 of the present disclosure.

FIG. 2 is schematic diagram of a sectional structure of Part A-A′ in FIG. 1.

FIG. 3 is schematic diagram of a sectional structure of Part B-B′ in FIG. 1.

FIG. 4 is a three-dimensional structural schematic diagram of a mobile communication device protective case according to Example 2 of the present disclosure that is put on a mobile phone.

FIG. 5 is a schematic diagram of an exploded structure of a mobile communication device protective case according to Example 2 of the present disclosure.

FIG. 6 is a three-dimensional structural schematic diagram of a mobile communication device protective case according to Example 3 of the present disclosure that is removed from a mobile phone.

FIG. 7 is a schematic diagram of an exploded structure of a mobile communication device protective case according to Example 3 of the present disclosure.

FIG. 8 is a three-dimensional structural schematic diagram of a mobile communication device protective case according to Example 4 of the present disclosure.

FIG. 9 is a schematic diagram of an exploded structure of a mobile communication device protective case according to Example 4 of the present disclosure.

FIG. 10 is a schematic diagram of a sectional structure of a membrane according to an example of the present disclosure.

FIG. 11 is a three-dimensional structural schematic diagram of a mobile communication device protective case according to Example 5 of the present disclosure.

FIG. 12 is a schematic diagram of an exploded structure of a mobile communication device protective case according to Example 5 of the present disclosure.

FIG. 13 is a schematic diagram of a planar structure of a mobile communication device protective case according to Example 5 of the present disclosure.

FIG. 14 is schematic diagram of a sectional structure of Part C-C′ in FIG. 13.

FIG. 15 is schematic diagram of a sectional structure of Part D-D′ in FIG. 13.

FIG. 16 is a structural schematic diagram of a middle shell of a mobile communication device protective case according to Example 5 of the present disclosure.

FIG. 17 is a structural schematic diagram of a first hard shell of a mobile communication device protective case according to Example 5 of the present disclosure.

FIG. 18 is a structural schematic diagram of a first soft shell of a mobile communication device protective case according to Example 5 of the present disclosure.

FIG. 19 is a three-dimensional structural schematic diagram of a back cover of a mobile communication device protective case according to Example 5 of the present disclosure.

Reference numerals in the accompanying drawings: 101. mobile phone; 102. side touch-sensitive button; 103. USB charging port;
201. housing;
1. middle shell; 11. first hard shell; 111. snap-fit block; 112. positioning block; 113. sealing slot; 114. snap-fit joint; 115. charging port; 12. first soft shell; 121. press button; 122. toggle button; 123. connecting groove; 124. pivot hole; 125. opening; 126. force-exerting end; 13. first step surface; 14. second step surface; 15. transition arc surface; 16. speaker hole;
2. back cover; 21. second hard shell; 211. flange; 212. notch; 213. shaped groove; 214. magnetic attraction member; 22. second soft shell; 221. snap-fit slot; 222. sealing ring; 223. positioning slot; 224. inner step; 23. third step surface; 24. tapered arc surface;
3. button opening;
4. membrane; 40. release layer; 41. fingerprint area; 42. fixed area; 43. soft plastic membrane; 44. glass membrane; 45. explosion-proof membrane layer; 46. glass layer; 47. oil-resistant layer; 48. first adhesive layer; 49. second adhesive layer;
5. screen membrane;
6. lens membrane; 61. cushioning pad;
7. waterproof membrane; 71. waterproof glue;
8. plug; 81. connector; and
9. lever; 91. force-bearing end; 92. pivot; 93. swinging end; and 94. toggle contact.

### DETAILED DESCRIPTIONS OF THE EMBODIMENTS

Specific embodiments of the present disclosure will be described in detail below with reference to the accompanying drawings.

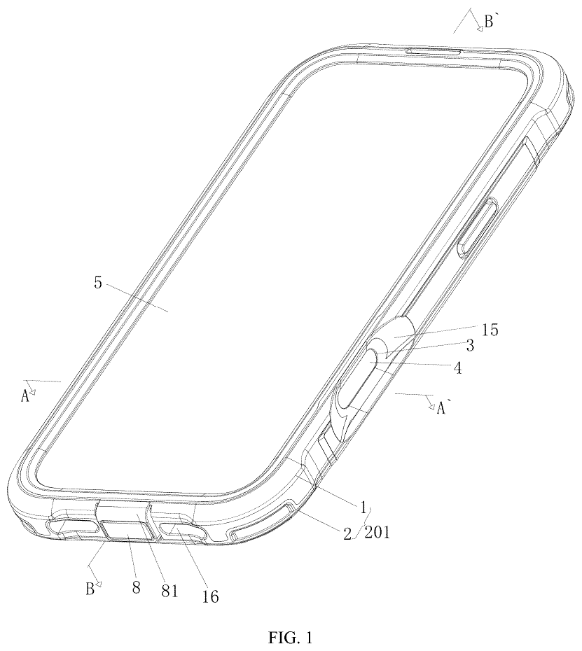

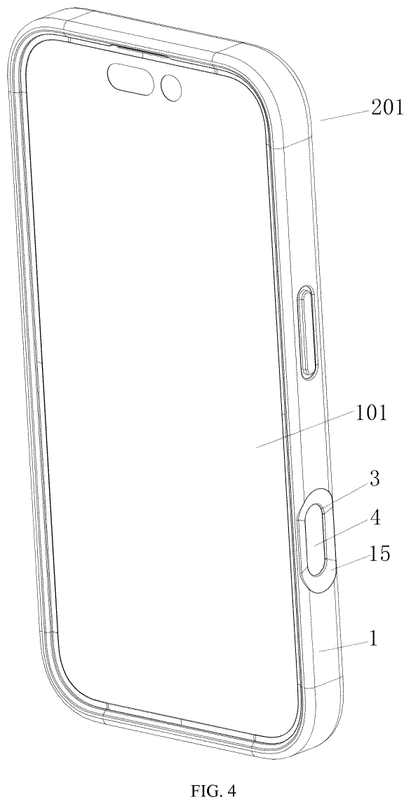

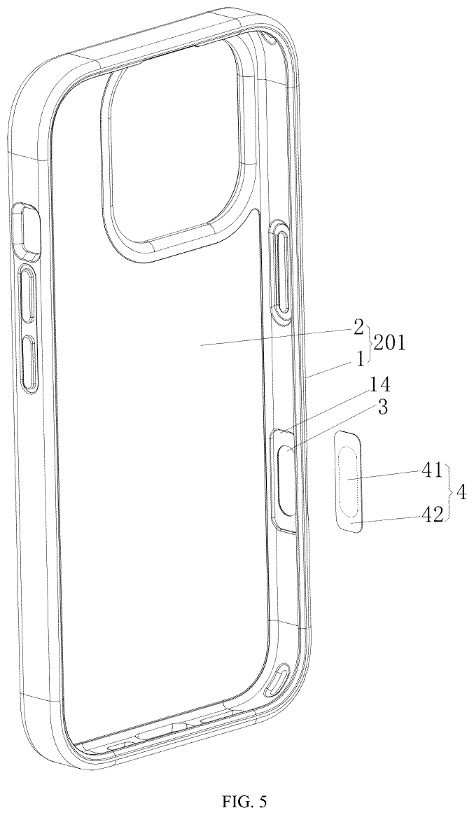

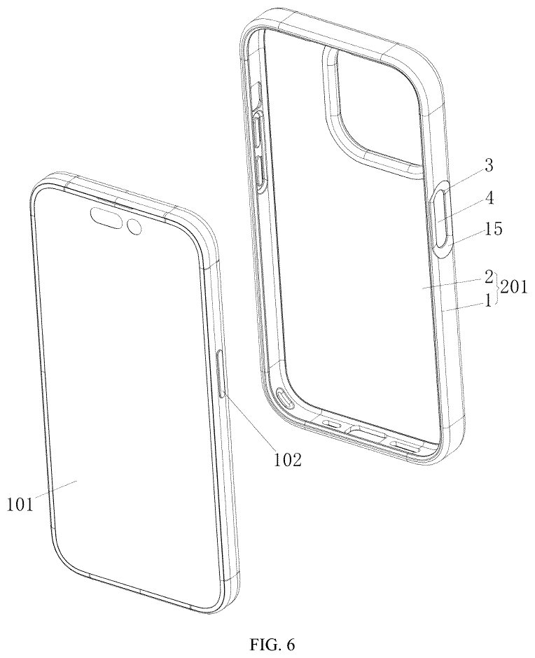

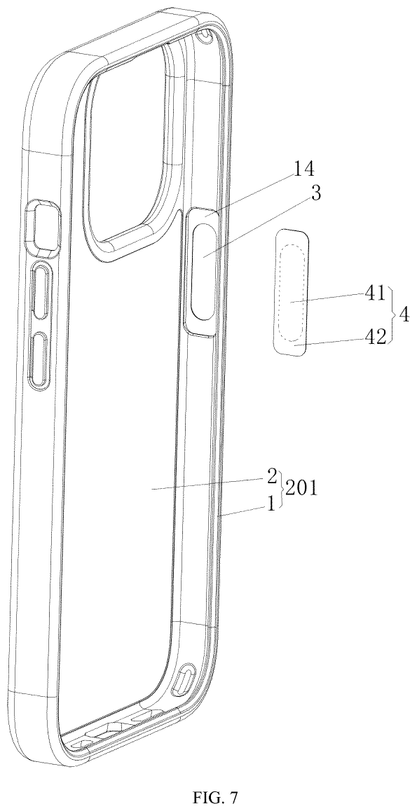

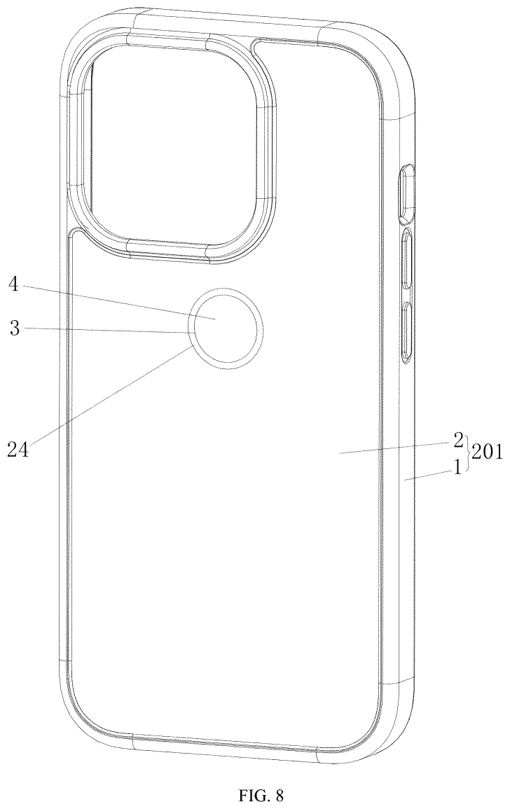

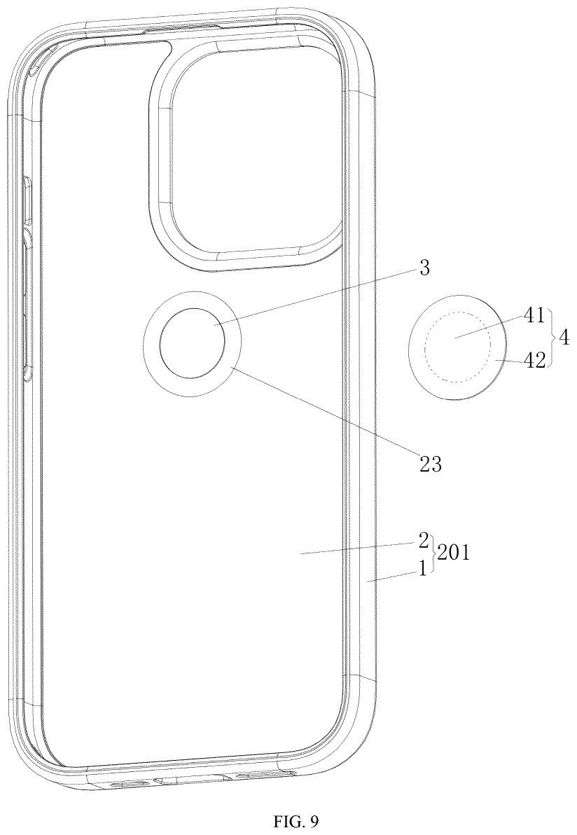

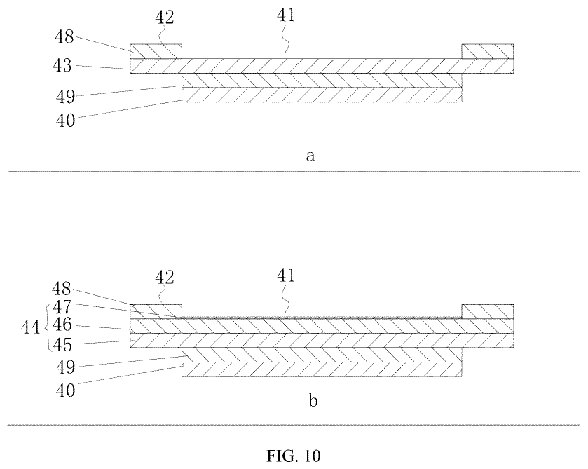

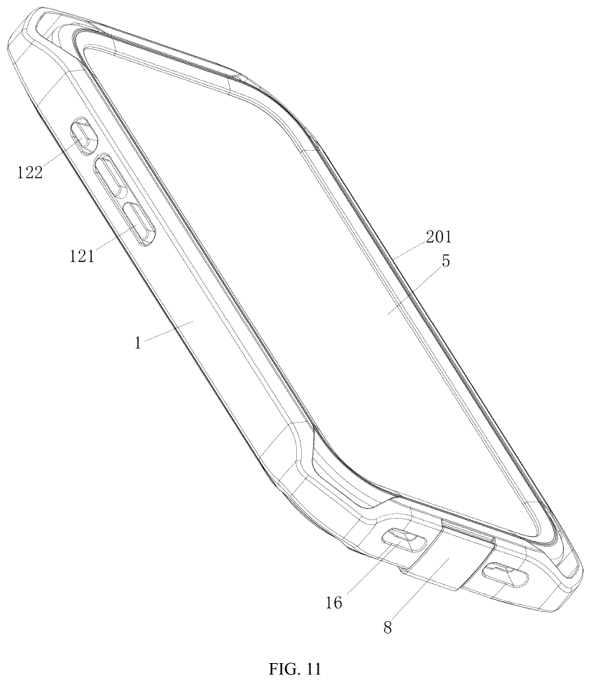

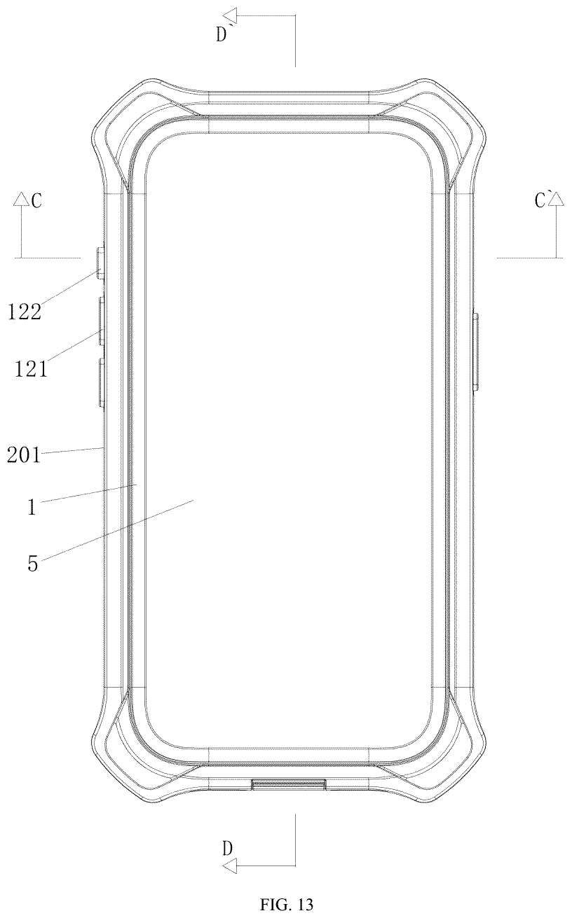

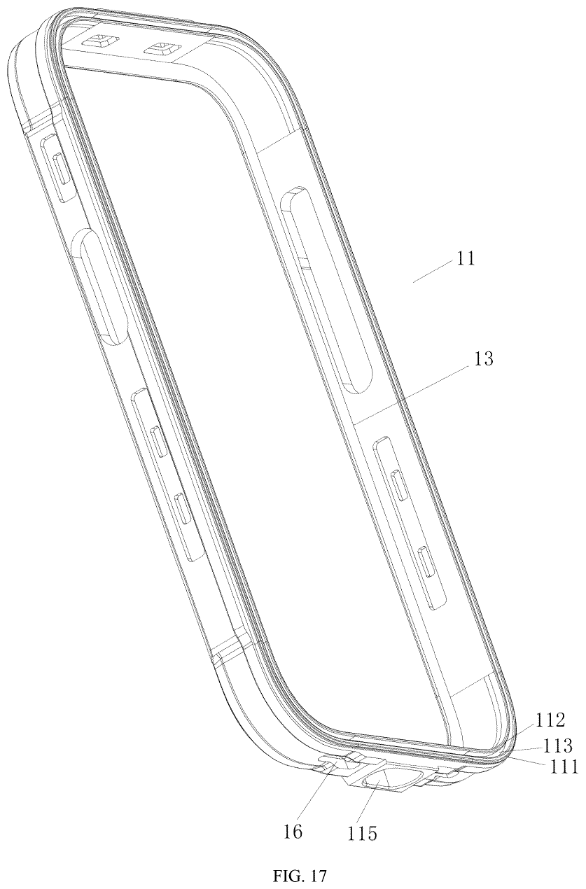

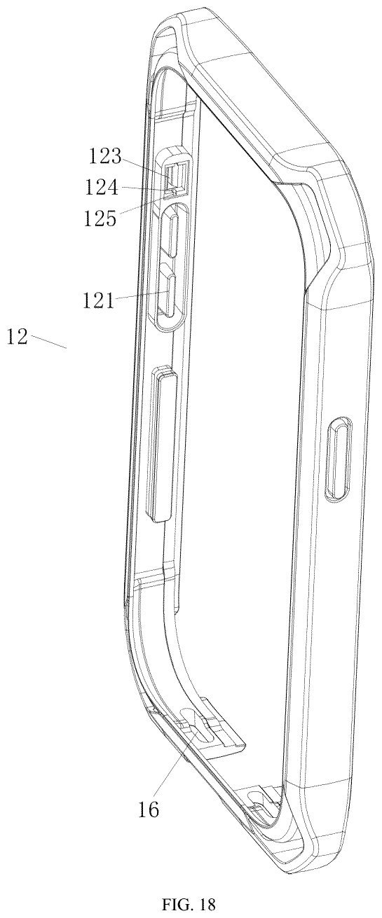

With reference to FIGS. 1-19, FIGS. 1-3 are structural schematic diagrams of a mobile communication device protective case according to Example 1, and the mobile communication device protective case in Example 1 is a first waterproof protective case and is used for a mobile phone 101 having a side touch-sensitive button 102; FIGS. 4 and 5 are structural schematic diagrams of a mobile communication device protective case according to Example 2, and the mobile communication device protective case in Example 2 is a first non-waterproof semi-enclosed protective case and is used for a mobile phone 101 having a side touch-sensitive button 102; FIGS. 6 and 7 are structural schematic diagrams of a mobile communication device protective case according to Example 3, and the mobile communication device protective case in Example 3 is a second non-waterproof semi-enclosed protective case and is used for a mobile phone 101 having a side touch-sensitive button 102; FIGS. 8 and 9 are structural schematic diagrams of a mobile communication device protective case according to Example 4, and the mobile communication device protective case in Example 4 is a third non-waterproof semi-enclosed protective case and is used for a mobile phone 101 having a rear touch-sensitive button; FIG. 10 is a schematic diagram of a sectional structure of a membrane 4 according to the four examples; and FIGS. 11 to 19 are structural schematic diagrams of a mobile communication device protective case according to Example 5, and the mobile communication device protective case in Example 5 is a second waterproof protective case and is used for a mobile phone 101 having a mute toggle key.

Specifically, in addition to a fingerprint unlocking function, the touch-sensitive buttons of the mobile phone 101 can also have various functions such as sliding to zoom in or out of pictures while browsing the pictures, switching images while browsing the pictures, sliding to control a focal length while taking photos, sliding to control a volume, tapping to take photos, and answering calls. The touch-sensitive buttons of the mobile phone 101 are divided into the side touch-sensitive button 102 and the rear touch-sensitive button. There are two types of side touch-sensitive button 102 of the mobile phone 101, specifically, a first type is to embed a fingerprint sensor into a side frame of the mobile phone 101 to form a standalone touch-sensitive button, and a second type is to integrate the fingerprint sensor into a power button on a side of the mobile phone 101, which serves as the power button and the touch-sensitive button. The mobile communication device protective case in Examples 1 and 2 is used for the mobile phone 101 having the first type of side touch-sensitive button 102, the mobile communication device protective case in Example 3 is used for the mobile phone 101 having the second type of side touch-sensitive button 102, and the bile communication device protective case in Example 4 is used for the mobile phone 101 having the rear touch-sensitive button.

### Example 1

As an optimal embodiment, this example involves a fully-enclosed waterproof protective case for a mobile phone 101 having a side touch-sensitive button 102, the protective case can provide the mobile phone 101 having greater protection and has excellent waterproof, dustproof, and drop-resistant protection.

With reference to FIGS. 1-3, a mobile communication device protective case includes a housing 201 put on a mobile phone 101, the housing 201 is provided with a button opening 3 at a position adapted to a touch-sensitive button, the button opening 3 is installed with a membrane 4, and the membrane 4 includes a fingerprint area 41 located in a center and a fixed area 42 surrounding the fingerprint area 41; the fixed area 42 is fixedly connected to the housing 201, the fingerprint area 41 is exposed from the button opening 3, and an inner side surface of the fingerprint area 41 is connected to the touch-sensitive button located at the button opening 3, such that a user's finger can be recognized by the touch-sensitive button via the fingerprint area 41 of the membrane 4. Specifically, the housing 201 includes a middle shell 1, and the membrane 4 is arranged on the middle shell 1 and is adapted to the side touch-sensitive button 102 of the mobile phone 101.

It should be further noted that the side touch-sensitive button 102 mainly recognizes a fingerprint by detecting capacitance changes between a fingerprint recess and a fingerprint pattern, and recognizes a corresponding touch action by detecting capacitance changes caused by the movement of the finger during touch. In order to enable the side touch-sensitive button 102 of the mobile phone 101 to better recognize operations by the user's finger, the membrane 4 can be made of a soft plastic membrane 43 or a glass membrane 44. With reference to FIG. 1, the membrane 4 is rectangular, and the button opening 3 is an oblong hole; the fingerprint area 41 of the membrane 4 is adapted to the button opening 3, the fixed area 42 is formed outside the fingerprint area 41, and the fingerprint area 41 in the oblong hole is well adapted to the side touch-sensitive button 102 of the mobile phone 101.

When the membrane 4 is a soft plastic membrane 43, with reference to Part a in FIG. 10, a thickness of the soft plastic membrane 43 in the fingerprint area 41 ranges from 0.1 mm to 0.4 mm, such that membrane 4 achieves a better balance and trade-off between providing good protection for the side touch-sensitive button 102 and enabling faster recognition of the fingerprint pattern and touch action by the side touch-sensitive button 102.

When the membrane 4 is a glass membrane 44, with reference to Part b in FIG. 10, the glass membrane 44 includes an explosion-proof membrane layer 45, a glass layer 46, and an oil-resistant layer 47 arranged in sequence, specifically, the explosion-proof membrane layer 45 is arranged on a side close to the touch-sensitive button, the oil-resistant layer 47 is exposed from the button opening 3, and the oil-resistant layer 47 is an anti-fingerprint (AF) oil coating sprayed and cured on a surface of the glass layer 46; and a thickness of the explosion-proof membrane layer 45 is 0.08-0.12 mm, and a thickness of the glass layer 46 is 0.18-0.22 mm.

It can be understood that the arrangement exhibits excellent protection performance, that is, the glass membrane 44 formed by the explosion-proof membrane layer 45 with the thickness of 0.08-0.12 mm and the glass layer 46 with the thickness of 0.18-0.22 mm exhibits excellent protection performance. For example, the explosion-proof membrane layer 45 with the thickness of 0.1 mm and the glass layer 46 with the thickness of 0.2 mm can form the glass membrane 44, and the glass membrane 44 has a moderate thickness. The AF anti-fingerprint oil coating can repel water and grease, such that the oil-resistant layer 47 capable of preventing oil from adhering is formed on the surface of the glass layer 46, thereby increasing the hydrophobic, oil-repelling, and anti-stain properties of the glass membrane 44.

In order to fix the membrane 4 to the housing 201, in this example, with reference to FIG. 10, an outer surface of the fixed area 42 of the membrane 4 is provided with a first adhesive layer 48, and the first adhesive layer 48 is bonded to a second step surface 14 of an inner side wall of the housing 201. In addition to adhesive fixation, other alternative methods can also be used to fix the membrane 4 to the housing 201. For example, the fixed area 42 of the membrane 4 can be fixed to the inner side wall of the housing 201 by ultrasonic welding or overmolding. When the housing 201 is formed by plastic injection molding and the overmolding is adopted, a plurality of through holes can be formed in the fixed area 42 of the membrane 4. During the overmolding process, the housing 201 will have fixing columns integrally formed at the through holes of the membrane 4, such that the membrane 4 is stably fixed onto the housing 201 through the overmolding. Ultrasonic welding can fix the fixed area 42 of the membrane 4 onto the second step surface 14, all of the methods are intended to stably fix the membrane 4 onto the middle shell 1 of the housing 201, so as to prevent the membrane 4 from detaching from the housing 201 during use.

It can be understood that for the arrangement, both the soft plastic membrane 43 and the glass membrane 44 can be fixed onto the housing 201 by the methods of adhesive fixation ultrasonic welding, and overmolding. Specifically, the first adhesive layer 48 needs to be a waterproof adhesive, and the waterproof performance between the membrane 4 and the housing 201 can be ensured after the membrane 4 is fixed onto the inner side wall of the housing 201.

In order to ensure that the membrane 4 does not affect the recognition of the fingerprint and touch actions of the finger by the side touch-sensitive button 102, in this example, with reference to FIG. 10, a second adhesive layer capable of conducting electricity 49 that is bonded and fixed onto the touch-sensitive button is arranged on the inner side surface of the fingerprint area 41 of the membrane 4, and the second adhesive layer 49 is provided with a peelable release layer 40 before the housing 201 is used.

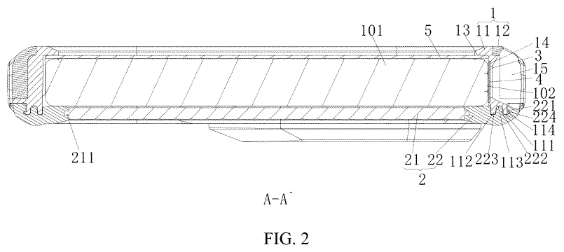

It should be further noted that, with reference to FIGS. 1 and 2, an outer side wall of the middle shell 1 is provided with a transition arc surface 15 around a hole edge close to the button opening 3, and the transition arc surface 15 forms a recess that is concave towards the button opening 3; and the concave area can be better adapted to a curved fingerprint surface of the user's finger, such that the fingerprint can be better oriented to the membrane 4 at the button opening 3, facilitating better recognition of finger operations by the side touch-sensitive button 102.

It can be understood that for the arrangement, the adhesive layer 49 is conductive adhesive, the membrane 4 is stably connected to the side touch-sensitive button 102, electrical conduction is formed between the membrane 4 and the side touch-sensitive button 102, and it is ensured that capacitance changes of the membrane 4 caused by the finger can be transmitted to the side touch-sensitive button 102, such that the side touch-sensitive button 102 can properly recognize the fingerprint and finger operations. Before the housing 201 is put on the mobile phone 101, the release layer 40 is removed to expose the second adhesive layer 49 of the membrane 4. When the housing 201 is put on the mobile phone 101, the membrane 4 is bonded onto an end face of the side touch-sensitive button 102 via the second adhesive layer 49, such that the membrane 4 is stably bonded onto the side touch-sensitive button 102 to avoid the presence of air between the membrane 4 and the side touch-sensitive button 102, which could affect the recognition of the fingerprint by the side touch-sensitive button 102. The membrane 4 is bonded and fixed to the side touch-sensitive button 102 via the second adhesive layer 49, and the membrane 4 can also be attached to the end face of side touch-sensitive button 102 by electrostatic adsorption.

In order to form a protective case with good waterproof performance, in this example, with reference to FIGS. 1-3, the housing 201 is a waterproof housing; the housing 201 includes the middle shell 1 and a back cover 2 that are snap-fitted together, the membrane 4 is arranged in the middle shell 1 and is adapted to the side touch-sensitive button 102 of the mobile phone 101; the middle shell 1 includes a first hard shell 11 and a first soft shell 12, the first soft shell 12 is plastically wrapped around an outer side of the first hard shell 11, and a first step surface 13 on an inner side wall of the first hard shell 11 is fixedly provided with a screen membrane 5; and the back cover 2 includes a second hard shell 21, a second soft shell 22, and a lens membrane 6, the second hard shell 21 is plastically wrapped and fixed in the second soft shell 22, the lens membrane 6 is fixed onto the second soft shell 22, the lens membrane 6 is located at a notch 212 of the second hard shell 21, and the first hard shell 11 and the second soft shell 22 are snap-fitted together.

It can be understood that for the arrangement, the first hard shell 11 and the second hard shell 21 are both made from PC, and the first soft shell 12 and the second soft shell 22 are both made from TPU; the first hard shell 11 and the second hard shell 21 are used as supporting frameworks of the middle shell 1 and the back cover 2, respectively, and the first soft shell 12 and the second soft shell 22 are used as cushioning rubber coating for the middle shell 1 and the back cover 2, respectively, such that the middle shell 1 and the back cover 2 have good protective performance. The membrane 4 is fixed onto an inner side wall of the middle shell 1, such that the membrane 4 can be well adapted to the side touch-sensitive button 102; and the middle shell 1 is provided with the screen membrane 5 on a screen side of the mobile phone 101, and the back cover 2 is provided with the lens membrane 6 on a rear camera lens side of the mobile phone 101, such that the housing 201 can have good waterproof performance.

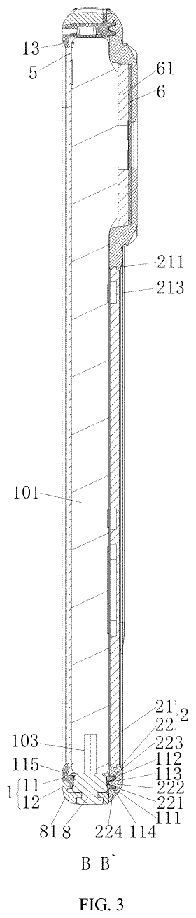

In order to guarantee the sealing between the middle shell 1 and the back cover 2, in this example, with reference to FIGS. 2 and 3, a circle of snap-fit blocks 111 and a circle of positioning blocks 112 are integrally formed on an end face of the first hard shell 11, a sealing slot 113 is formed between the snap-fit blocks 111 and the positioning blocks 112, and a snap-fit slot 221, a sealing ring 222, and a positioning slot 223 are integrally formed in a position near an edge of the second soft shell 22; and when the middle shell 1 and the back cover 2 are snap-fitted together, the snap-fit blocks 111 and the positioning blocks 112 of the first hard shell 11 are respectively snapped into the snap-fit slot 221 and the positioning slot 223 of the second soft shell 22, a snap-fit joint 114 of the snap-fit block 111 is snap-fitted on an inner step 224 in the snap-fit slot 221, and the sealing ring 222 of the second soft shell 22 is snap-fitted into the sealing slot 113 of the first hard shell 11, such that a sealing structure between the first hard shell 11 and second soft shell 22 is formed, and the middle shell 1 and the back cover 2 are assembled into a waterproof housing 201 through the sealing structure.

It can be understood that in the arrangement, the middle shell 1 and the back cover 2 can be snap-fitted together through the sealing structure to form a fully-enclosed waterproof protective case; the snap-fit blocks 111 of the first hard shell 11 and the snap-fit slot 221 of the second soft shell 22 form a first ring sealing structure, and the snap-fit joint 114 of the snap-fit blocks 111 can be snap-fitted on the inner step 224 in the snap-fit slot 221, ensuring stable snap-fitting connection between the first hard shell 11 and the second soft shell 22. The sealing slot 113 of the first hard shell 11 and the sealing ring 222 of the second soft shell 22 form a second ring sealing structure, and the flexible sealing ring 222 is capable of squeezing against an inner wall of the sealing slot 113, such that the sealing performance can be improved; and the positioning blocks 112 of the first hard shell 11 and the positioning slot 223 of the second soft shell 22 form a third ring sealing structure, and the hard positioning blocks 112 with a harder texture can fix the positioning slot 223, preventing the second soft shell 22 with a softer texture from sliding relative to the first hard shell 11, and destroying the sealing effect of the sealing structure.

It should be further noted that a connection between the middle shell 1 and the back cover 2 is arranged between the first hard shell 11 and the second soft shell 22, combination of the hard and soft material can ensure better sealing performance of the waterproof sealing structure. A flange 211 is formed on an edge of the second hard shell 21 in a protruding manner, and the arrangement of the flange 211 is conducive to strengthening a bonding strength between the second hard shell 21 and the second soft shell 22, preventing them from debonding.

In order to waterproof and seal a USB charging port 103 of the mobile phone 101, in this example, with reference to FIG. 3, the first soft shell 12 is integrally formed with a connector 81, the connector 81 is snap-fitted with a plug 8, the first hard shell 11 is provided with a charging port 115, and the plug 8 is detachably fitted with the charging port 115.

It can be understood that for the arrangement, the plug 8 is made of silicone material, which is soft and can be squeezed to block the charging port 115 of the first hard shell 11, ensuring that no water enters the USB charging port 103. When the mobile phone 101 needs to be inserted into a charging socket, the plug 8 can be removed. The plug 8 is connected to the first soft shell 12 through the connector 81, and the plug 8 will not fall off the housing 201, such that the charging port 115 can be re-blocked by the plug 8 once charging is completed. The situation is a case where a charging plug really needs to be inserted and removed. When wireless charging is available, the first hard shell 11 does not need to be provided with the charging port 115 at the USB charging port 103, in which case, the plug 8 is not needed, either.

In order to ensure a speaker playback function of the mobile phone 101, in this example, each of the first hard shell 11 and the first soft shell 12 is provided with a speaker hole 16, and a waterproof membrane 7 is fixedly arranged at the speaker hole 16 of the first hard shell 11.

It can be understood that for the arrangement, the waterproof membrane 7 is membrane material of 0.5 mm, which has minimal sound blocking property, thereby ensuring that the speaker playback function of the mobile phone 101 is not significantly affected. The waterproof membrane 7 is fixed onto an inner wall of the first hard shell 11 with waterproof glue 71, thereby ensuring good waterproof performance at the speaker holes 16.

The mobile communication device protective case in this example accommodates the side touch-sensitive button 102, the membrane 4 is arranged on a side of the housing 201 corresponding to the side touch-sensitive button 102, the membrane 4 adopts a double-sided adhesive design, one side of the membrane is bonded onto the housing 201, and the other side thereof is bonded onto the side touch-sensitive button 102, such that the membrane 4 is stably connected to the side touch-sensitive button 102 without affecting normal use of the side touch-sensitive button 102. The side touch-sensitive button 102 is protected by the membrane 4, preventing the side touch-sensitive button 102 from being scratched. In addition to protecting the side touch-sensitive button 102, the membrane 4 also enables the protective case to achieve a sealing effects at the side touch-sensitive button 102, forming a triple-proof protective case suitable for the mobile phone 101 with side touch sensing functionality. At a snap-fitted connection between the middle shell 1 and the back cover 2, sealing is achieved through a concentric three-ring positioning and snap-fit sealing structure; and the screen membrane 5 and the lens membrane 6 are used on the screen and camera sides, respectively, the waterproof membrane 7 is used at the speaker holes 16, and the plug 8 is used at the charging port 115, ensuring the waterproof sealing performance of the entire housing 201.

### Example 2

This example provides a semi-enclosed protective case, and the semi-enclosed protective case is relatively thin, thereby providing a good grip feeling. When the semi-enclosed protective case can be used for a mobile phone 101 having a side touch-sensitive button 102, drop resistance of the mobile phone 101 can be improved.

With reference to FIGS. 4 and 5, a mobile communication device protective case includes a housing 201 put on a mobile phone 101, the housing 201 is provided with a button opening 3 at a position adapted to a touch-sensitive button, the button opening 3 is installed with a membrane 4, and the membrane 4 includes a fingerprint area 41 located in a center and a fixed area 42 surrounding the fingerprint area 41; the fixed area 42 is fixedly connected to the housing 201, the fingerprint area 41 is exposed from the button opening 3, and an inner side surface of the fingerprint area 41 is connected to the touch-sensitive button located at the button opening 3, such that a user's finger can be recognized by the touch-sensitive button via the fingerprint area 41 of the membrane 4. Specifically, the housing 201 includes a middle shell 1, and the membrane 4 is arranged on the middle shell 1 and is adapted to the side touch-sensitive button 102 of the mobile phone 101.

It should be further noted that the side touch-sensitive button 102 mainly recognizes a fingerprint by detecting capacitance changes between a fingerprint recess and a fingerprint pattern, and recognizes a corresponding touch action by detecting capacitance changes caused by the movement of the finger during touch. In order to enable the side touch-sensitive button 102 of the mobile phone 101 to better recognize operations by the user's finger, the membrane 4 can be made of a soft plastic membrane 43 or a glass membrane 44. With reference to FIGS. 4 and 5, the membrane 4 is rectangular, and the button opening 3 is an oblong hole; the fingerprint area 41 of the membrane 4 is adapted to the button opening 3, the fixed area 42 is formed outside the fingerprint area 41, and the fingerprint area 41 in the oblong hole is well adapted to the side touch-sensitive button 102 of the mobile phone 101.

When the membrane 4 is a soft plastic membrane 43, with reference to Part a in FIG. 10, a thickness of the soft plastic membrane 43 in the fingerprint area 41 ranges from 0.1 mm to 0.4 mm, such that membrane 4 achieves a better balance and trade-off between providing good protection for the side touch-sensitive button 102 and enabling faster recognition of the fingerprint pattern and touch action by the side touch-sensitive button 102.

When the membrane 4 is a glass membrane 44, with reference to Part b in FIG. 10, the glass membrane 44 includes an explosion-proof membrane layer 45, a glass layer 46, and an oil-resistant layer 47 arranged in sequence, specifically, the explosion-proof membrane layer 45 is arranged on a side close to the touch-sensitive button, the oil-resistant layer 47 is exposed from the button opening 3, and the oil-resistant layer 47 is an anti-fingerprint (AF) oil coating sprayed and cured on a surface of the glass layer 46; and a thickness of the explosion-proof membrane layer 45 is 0.08-0.12 mm, and a thickness of the glass layer 46 is 0.18-0.22 mm.

It can be understood that the arrangement exhibits excellent protection performance, that is, the glass membrane 44 formed by the explosion-proof membrane layer 45 with the thickness of 0.08-0.12 mm and the glass layer 46 with the thickness of 0.18-0.22 mm exhibits excellent protection performance. For example, the explosion-proof membrane layer 45 with the thickness of 0.1 mm and the glass layer 46 with the thickness of 0.2 mm can form the glass membrane 44, and the glass membrane 44 has a moderate thickness. The AF anti-fingerprint oil coating can repel water and grease, such that the oil-resistant layer 47 capable of preventing oil from adhering is formed on the surface of the glass layer 46, thereby increasing the hydrophobic, oil-repelling, and anti-stain properties of the glass membrane 44.

In order to fix the membrane 4 to the housing 201, in this example, with reference to FIG. 10, an outer surface of the fixed area 42 of the membrane 4 is provided with a first adhesive layer 48, the first adhesive layer 48 is bonded to a second step surface 14 of an inner side wall of the housing 201. In addition to adhesive fixation, other alternative methods can also be used to fix the membrane 4 to the housing 201. For example, the fixed area 42 of the membrane 4 can be fixed to the inner side wall of the housing 201 by ultrasonic welding or overmolding. When the housing 201 is formed by plastic injection molding and the overmolding is adopted, a plurality of through holes can be formed in the fixed area 42 of the membrane 4. During the overmolding process, the housing 201 will have fixing columns integrally formed at the through holes of the membrane 4, such that the membrane 4 is stably fixed onto the housing 201 through the overmolding. Ultrasonic welding can fix the fixed area 42 of the membrane 4 onto the second step surface 14, all of the methods are intended to stably fix the membrane 4 onto the middle shell 1 of the housing 201, so as to prevent the membrane 4 from detaching from the housing 201 during use.

It can be understood that for the arrangement, both the soft plastic membrane 43 and the glass membrane 44 can be fixed onto the housing 201 by the methods of adhesive fixation ultrasonic welding, and overmolding. Specifically, the first adhesive layer 48 needs to be a waterproof adhesive, and the waterproof performance between the membrane 4 and the housing 201 can be ensured after the membrane 4 is fixed onto the inner side wall of the housing 201.

In order to ensure that the membrane 4 does not affect the recognition of the fingerprint by the side touch-sensitive button 102, in this example, with reference to FIG. 10, a second adhesive layer capable of conducting electricity 49 that is bonded and fixed onto the touch-sensitive button is arranged on the inner side surface of the fingerprint area 41 of the membrane 4, and the second adhesive layer 49 is provided with a peelable release layer 40 before the housing 201 is used.

It should be further noted that, with reference to FIGS. 4 and 5, an outer side wall of the middle shell 1 is provided with a transition arc surface 15 around a hole edge close to the button opening 3, and the transition arc surface 15 forms a recess that is concave towards the button opening 3; and the concave area can be better adapted to a curved fingerprint surface of the user's finger, such that the fingerprint can be better oriented to the membrane 4 at the button opening 3, facilitating better recognition of finger operations by the side touch-sensitive button 102.

It can be understood that for the arrangement, the adhesive layer 49 is conductive adhesive, the membrane 4 is stably connected to the side touch-sensitive button 102, electrical conduction is formed between the membrane 4 and the side touch-sensitive button 102, and it is ensured that capacitance changes of the membrane 4 caused by the finger can be transmitted to the side touch-sensitive button 102, such that the side touch-sensitive button 102 can properly recognize the fingerprint and finger operations. Before the housing 201 is put on the mobile phone 101, the release layer 40 is removed to expose the second adhesive layer 49 of the membrane 4. When the housing 201 is put on the mobile phone 101, the membrane 4 is bonded onto an end face of the side touch-sensitive button 102 via the second adhesive layer 49, such that the membrane 4 is stably bonded onto the side touch-sensitive button 102 to avoid the presence of air between the membrane 4 and the side touch-sensitive button 102, which could affect the recognition of the fingerprint by the side touch-sensitive button 102. The membrane 4 is bonded and fixed onto the side touch-sensitive button 102 via the second adhesive layer 49, and the membrane 4 can also be attached to the end face of side touch-sensitive button 102 by electrostatic adsorption.

The mobile communication device protective case in this example accommodates the side touch-sensitive button, the membrane 4 is arranged on a side of the housing 201 corresponding to the side touch-sensitive button 102, such that the membrane 4 can protect the side touch-sensitive button 102; the membrane 4 adopts a double-sided adhesive design, one side of the membrane is bonded onto the housing 201, and the other side thereof is bonded onto the side touch-sensitive button 102, such that the membrane 4 is stably connected to the side touch-sensitive button 102 without affecting normal use of the side touch-sensitive button 102. The side touch-sensitive button 102 is protected by the membrane 4, preventing the side touch-sensitive button 102 from being scratched.

### Example 3

Same as Example 2, this example also provides a semi-enclosed protective case used for a mobile phone 101 having a side touch-sensitive button 102, the difference lies in a position where the membrane 4 is arranged and a position of the side touch-sensitive button 102 that cooperates with the membrane 4. As shown in FIG. 6, the side touch-sensitive button 102 of the mobile phone 101 is integrated on a power button.

With reference to FIGS. 6 and 7, a mobile communication device protective case includes a housing 201 put on a mobile phone 101, the housing 201 is provided with a button opening 3 at a position adapted to a touch-sensitive button, the button opening 3 is installed with a membrane 4, and the membrane 4 includes a fingerprint area 41 located in a center and a fixed area 42 surrounding the fingerprint area 41; the fixed area 42 is fixedly connected to the housing 201, the fingerprint area 41 is exposed from the button opening 3, and an inner side surface of the fingerprint area 41 is connected to the touch-sensitive button located at the button opening 3, such that a user's finger can be recognized by the touch-sensitive button via the fingerprint area 41 of the membrane 4. Specifically, the housing 201 includes a middle shell 1, and the membrane 4 is arranged on the middle shell 1 and is adapted to the side touch-sensitive button 102 of the mobile phone 101.

It should be further noted that the side touch-sensitive button 102 mainly recognizes a fingerprint by detecting capacitance changes between a fingerprint recess and a fingerprint pattern, and recognizes a corresponding touch action by detecting capacitance changes caused by the movement of the finger during touch. In order to enable the side touch-sensitive button 102 of the mobile phone 101 to better recognize operations by the user's finger, the membrane 4 can be made of a soft plastic membrane 43 or a glass membrane 44. With reference to FIGS. 6 and 7, the membrane 4 is rectangular, and the button opening 3 is an oblong hole; the fingerprint area 41 of the membrane 4 is adapted to the button opening 3, the fixed area 42 is formed outside the fingerprint area 41, and the fingerprint area 41 in the oblong hole is well adapted to the side touch-sensitive button 102 of the mobile phone 101.

When the membrane 4 is a soft plastic membrane 43, with reference to Part a in FIG. 10, a thickness of the soft plastic membrane 43 in the fingerprint area 41 ranges from 0.1 mm to 0.4 mm, such that membrane 4 achieves a better balance and trade-off between providing good protection for the side touch-sensitive button 102 and enabling faster recognition of the fingerprint pattern and touch action by the side touch-sensitive button 102.

When the membrane 4 is a glass membrane 44, with reference to Part b in FIG. 10, the glass membrane 44 includes an explosion-proof membrane layer 45, a glass layer 46, and an oil-resistant layer 47 arranged in sequence, specifically, the explosion-proof membrane layer 45 is arranged on a side close to the touch-sensitive button, the oil-resistant layer 47 is exposed from the button opening 3, and the oil-resistant layer 47 is an anti-fingerprint (AF) oil coating sprayed and cured on a surface of the glass layer 46; and a thickness of the explosion-proof membrane layer 45 is 0.08-0.12 mm, and a thickness of the glass layer 46 is 0.18-0.22 mm.

It can be understood that the arrangement exhibits excellent protection performance, that is, the glass membrane 44 formed by the explosion-proof membrane layer 45 with the thickness of 0.08-0.12 mm and the glass layer 46 with the thickness of 0.18-0.22 mm exhibits excellent protection performance. For example, the explosion-proof membrane layer 45 with the thickness of 0.1 mm and the glass layer 46 with the thickness of 0.2 mm can form the glass membrane 44, and the glass membrane 44 has a moderate thickness. The AF anti-fingerprint oil coating can repel water and grease, such that the oil-resistant layer 47 capable of preventing oil from adhering is formed on the surface of the glass layer 46, thereby increasing the hydrophobic, oil-repelling, and anti-stain properties of the glass membrane 44.

In order to fix the membrane 4 to the housing 201, in this example, with reference to FIG. 10, an outer surface of the fixed area 42 of the membrane 4 is provided with a first adhesive layer 48, the first adhesive layer 48 is bonded to a second step surface 14 of an inner side wall of the housing 201. In addition to adhesive fixation, other alternative methods can also be used to fix the membrane 4 to the housing 201. For example, the fixed area 42 of the membrane 4 can be fixed to the inner side wall of the housing 201 by ultrasonic welding or overmolding. When the housing 201 is formed by plastic injection molding and the overmolding is adopted, a plurality of through holes can be formed in the fixed area 42 of the membrane 4. During the overmolding process, the housing 201 will have fixing columns integrally formed at the through holes of the membrane 4, such that the membrane 4 is stably fixed onto the housing 201 through the overmolding. Ultrasonic welding can fix the fixed area 42 of the membrane 4 onto the second step surface 14, all of the methods are intended to stably fix the membrane 4 onto the middle shell 1 of the housing 201, so as to prevent the membrane 4 from detaching from the housing 201 during use.

It can be understood that for the arrangement, both the soft plastic membrane 43 and the glass membrane 44 can be fixed onto the housing 201 by the methods of adhesive fixation ultrasonic welding, and overmolding. Specifically, the first adhesive layer 48 needs to be a waterproof adhesive, and the waterproof performance between the membrane 4 and the housing 201 can be ensured after the membrane 4 is fixed onto the inner side wall of the housing 201.

In order to ensure that the membrane 4 does not affect the recognition of the fingerprint by the side touch-sensitive button 102, in this example, with reference to FIG. 10, a second adhesive layer capable of conducting electricity 49 that is bonded and fixed onto the touch-sensitive button is arranged on the inner side surface of the fingerprint area 41 of the membrane 4, and the second adhesive layer 49 is provided with a peelable release layer 40 before the housing 201 is used.

It should be further noted that, with reference to FIG. and 7, an outer side wall of the middle shell 1 is provided with a transition arc surface 15 around a hole edge close to the button opening 3, and the transition arc surface 15 forms a recess that is concave towards the button opening 3; and the concave area can be better adapted to a curved fingerprint surface of the user's finger, such that the fingerprint can be better oriented to the membrane 4 at the button opening 3, facilitating better recognition of finger operations by the side touch-sensitive button 102.

It can be understood that for the arrangement, the adhesive layer 49 is conductive adhesive, the membrane 4 is stably connected to the side touch-sensitive button 102, electrical conduction is formed between the membrane 4 and the side touch-sensitive button 102, and it is ensured that capacitance changes of the membrane 4 caused by the finger can be transmitted to the side touch-sensitive button 102, such that the side touch-sensitive button 102 can properly recognize the fingerprint and finger operations. Before the housing 201 is put on the mobile phone 101, the release layer 40 is removed to expose the second adhesive layer 49 of the membrane 4. When the housing 201 is put on the mobile phone 101, the membrane 4 is bonded onto an end face of the side touch-sensitive button 102 via the second adhesive layer 49, such that the membrane 4 is stably bonded onto the side touch-sensitive button 102 to avoid the presence of air between the membrane 4 and the side touch-sensitive button 102, which could affect the recognition of the fingerprint by the side touch-sensitive button 102. The membrane 4 is bonded and fixed onto the side touch-sensitive button 102 via the second adhesive layer 49, and the membrane 4 can also be attached to the end face of side touch-sensitive button 102 by electrostatic adsorption.

The mobile communication device protective case in this example accommodates the side touch-sensitive button 102 (the power button), the membrane 4 is arranged on a side of the housing 201 corresponding to the side touch-sensitive button 102, such that the membrane 4 can protect the side touch-sensitive button 102; the membrane 4 adopts a double-sided adhesive design, one side of the membrane is bonded onto the housing 201, and the other side thereof is bonded onto the side touch-sensitive button 102, such that the membrane 4 is stably connected to the side touch-sensitive button 102, ensuring that the side touch-sensitive button 102 can well recognize finger operations through the membrane 4 without affecting normal use of the side touch-sensitive button 102. The side touch-sensitive button 102 is protected by the membrane 4, preventing the side touch-sensitive button 102 from being scratched.

### Example 4

This example provides a semi-enclosed protective case used for a mobile phone 101 having a rear touch-sensitive button, and the semi-enclosed protective case is relatively thin, such that good grip feeling can be improved, and drop resistance of the mobile phone 101 can be improved.

With reference to FIGS. 8 and 9, a mobile communication device protective case includes a housing 201 put on a mobile phone 101, the housing 201 is provided with a button opening 3 at a position adapted to a touch-sensitive button, the button opening 3 is installed with a membrane 4, and the membrane 4 includes a fingerprint area 41 located in a center and a fixed area 42 surrounding the fingerprint area 41; the fixed area 42 is fixedly connected to the housing 201, the fingerprint area 41 is exposed from the button opening 3, and an inner side surface of the fingerprint area 41 is connected to the touch-sensitive button located at the button opening 3, such that a user's finger can be recognized by the touch-sensitive button via the fingerprint area 41 of the membrane 4. Specifically, the housing 201 includes a back cover 2, and the membrane 4 is arranged on the back cover 2 and is adapted to the rear touch-sensitive button of the mobile phone 101.

It should be further noted that the rear touch-sensitive button mainly recognizes a fingerprint by detecting capacitance changes between a fingerprint recess and a fingerprint pattern, and recognizes a corresponding touch action by detecting capacitance changes caused by the movement of the finger during touch. The rear touch-sensitive button is mostly embedded in a back panel of the mobile phone 101 and is arranged below a rear camera, a shape of the membrane 4 is the same as that of the rear touch-sensitive button. This example takes a circular rear touch-sensitive button as an example. With reference to FIGS. 8 and 9, the membrane 4 in this example is circular, a shape of the button opening 3 is also circular, the circular fingerprint area 41 in a center of the membrane 4 is adapted to the button opening 3, and the circular fixed area 42 on an outer side of the fingerprint area 41 of the membrane 4 is fixed onto a third step surface 23 on an outer circumference of the button opening 3. In order to enable the rear touch-sensitive button to better recognize operations by the user's finger, the membrane 4 can be made of a soft plastic membrane 43 or a glass membrane 44.

When the membrane 4 is a soft plastic membrane 43, with reference to Part a in FIG. 10, a thickness of the soft plastic membrane 43 in the fingerprint area 41 ranges from 0.1 mm to 0.4 mm, such that membrane 4 achieves a better balance and trade-off between providing good protection for the rear touch-sensitive button and enabling faster recognition of the fingerprint pattern and touch action by the rear touch-sensitive button.

When the membrane 4 is a glass membrane 44, with reference to Part b in FIG. 10, the glass membrane 44 includes an explosion-proof membrane layer 45, a glass layer 46, and an oil-resistant layer 47 arranged in sequence, specifically, the explosion-proof membrane layer 45 is arranged on a side close to the touch-sensitive button, the oil-resistant layer 47 is exposed from the button opening 3, and the oil-resistant layer 47 is an anti-fingerprint (AF) oil coating sprayed and cured on a surface of the glass layer 46; and a thickness of the explosion-proof membrane layer 45 is 0.08-0.12 mm, and a thickness of the glass layer 46 is 0.18-0.22 mm.

It can be understood that the arrangement exhibits excellent protection performance, that is, the glass membrane 44 formed by the explosion-proof membrane layer 45 with the thickness of 0.08-0.12 mm and the glass layer 46 with the thickness of 0.18-0.22 mm exhibits excellent protection performance. For example, the explosion-proof membrane layer 45 with the thickness of 0.1 mm and the glass layer 46 with the thickness of 0.2 mm can form the glass membrane 44, and the glass membrane 44 has a moderate thickness. The AF anti-fingerprint oil coating can repel water and grease, such that the oil-resistant layer 47 capable of preventing oil from adhering is formed on the surface of the glass layer 46, thereby increasing the hydrophobic, oil-repelling, and anti-stain properties of the glass membrane 44.

In order to enable the rear touch-sensitive button of the mobile phone 101 to better recognize a user's fingerprint, in this example, with reference to FIG. 8, the back cover 2 of the housing 201 is provided with a tapered arc surface 24 around a hole edge close to the button opening 3, and the tapered arc surface 24 forms a recess that is concave towards the button opening 3; and the concave area can be better adapted to a fingerprint surface of the user's finger, such that the fingerprint can be better oriented to the mobile phone 101 at the button opening 3.

In order to fix the membrane 4 to the housing 201, in this example, with reference to FIG. 10, an outer surface of the fixed area 42 of the membrane 4 is provided with a first adhesive layer 48, the first adhesive layer 48 is bonded to the third step surface 23 on the back cover 2 of the housing 201. In addition to adhesive fixation, other alternative methods can also be used to fix the membrane 4 to the housing 201. For example, the fixed area 42 of the membrane 4 can be fixed to the back cover 2 of the housing 201 by ultrasonic welding or overmolding. When the housing 201 is formed by plastic injection molding and the overmolding is adopted, a plurality of through holes can be formed in the fixed area 42 of the membrane 4. During the overmolding process, the housing 201 will have fixing columns integrally formed at the through holes of the membrane 4, such that the membrane 4 is stably fixed onto the housing 201 through the overmolding. Ultrasonic welding can fix the fixed area 42 of the membrane 4 onto the third step surface 23, all of the methods are intended to stably fix the membrane 4 onto the back cover 2 of the housing 201, so as to prevent the membrane 4 from detaching from the housing 201 during use.

It can be understood that for the arrangement, both the soft plastic membrane 43 and the glass membrane 44 can be fixed onto the housing 201 by the methods of adhesive fixation ultrasonic welding, and overmolding. Specifically, the first adhesive layer 48 needs to be a waterproof adhesive, and the waterproof performance between the membrane 4 and the housing 201 can be ensured after the membrane 4 is fixed onto the inner side wall of the housing 201.

In order to ensure that the membrane 4 does not affect the recognition of the fingerprint by the rear touch-sensitive button, in this example, with reference to FIG. 10, a second adhesive layer capable of conducting electricity 49 that is bonded and fixed onto the touch-sensitive button is arranged on the inner side surface of the fingerprint area 41 of the membrane 4, and the second adhesive layer 49 is provided with a peelable release layer 40 before the housing 201 is used.

It can be understood that through the arrangement, that is, the adhesive layer 49 is conductive adhesive, the membrane 4 is stably connected to the rear touch-sensitive button, electrical conduction is formed between the membrane 4 and the rear touch-sensitive button, and it is ensured that capacitance changes of the membrane 4 caused by the finger can be transmitted to the rear touch-sensitive button, such that the rear touch-sensitive button can properly recognize the fingerprint and finger operations. Before the housing 201 is put on the mobile phone 101, the release layer 40 is removed to expose the second adhesive layer 49 of the membrane 4. When the housing 201 is put on the mobile phone 101, the membrane 4 is bonded onto an end surface of the rear touch-sensitive button via the second adhesive layer 49, such that the membrane 4 is stably bonded onto the rear touch-sensitive button to avoid the presence of air between the membrane 4 and the rear touch-sensitive button, which could affect the recognition of the fingerprint by the rear touch-sensitive button. The membrane 4 is bonded and fixed onto the rear touch-sensitive button via the second adhesive layer 49, and the membrane 4 can also be attached to the end surface of rear touch-sensitive button by electrostatic adsorption.

The mobile communication device protective case in this example accommodates the rear touch-sensitive button, the membrane 4 is arranged on the back cover 2 of the housing 201 corresponding to the rear touch-sensitive button, such that the membrane 4 can protect the rear touch-sensitive button; the membrane 4 adopts a double-sided adhesive design, one side of the membrane is bonded onto the housing 201, and the other side thereof is bonded onto the rear touch-sensitive button, such that the membrane 4 is stably connected to the rear touch-sensitive button without affecting normal use of the rear touch-sensitive button. The rear touch-sensitive button is protected by the membrane 4, preventing the rear touch-sensitive button from being scratched.

### Example 5

This example provides a fully-enclosed waterproof protective case used for a mobile phone 101 having a mute toggle key, and the protective case can provide the mobile phone 101 with greater protection, featuring excellent waterproof, dustproof, and drop-resistant protection.

With reference to FIGS. 11-19, a mobile communication device protective case includes a housing 201 put on a mobile phone 101, the housing 201 is provided with a button opening 3 at a position adapted to a touch-sensitive button, the button opening 3 is installed with a membrane 4, and the membrane 4 includes a fingerprint area 41 located in a center and a fixed area 42 surrounding the fingerprint area 41; the fixed area 42 is fixedly connected to the housing 201, the fingerprint area 41 is exposed from the button opening 3, and an inner side surface of the fingerprint area 41 is connected to the touch-sensitive button located at the button opening 3, such that a user's finger can be recognized by the touch-sensitive button via the fingerprint area 41 of the membrane 4.

In order to form a protective case with good waterproof performance, in this example, with reference to FIGS. 11-19, the housing 201 is a waterproof housing 201; the housing 201 includes a middle shell 1 and a back cover 2 that are snap-fitted together; the middle shell 1 includes a first hard shell 11 and a first soft shell 12, the first soft shell 12 is plastically wrapped around an outer side of the first hard shell 11, and a first step surface 13 on an inner side wall of the first hard shell 11 is fixedly provided with a screen membrane 5; and the back cover 2 includes a second hard shell 21, a second soft shell 22, and a lens membrane 6, the second hard shell 21 is plastically wrapped and fixed in the second soft shell 22, the lens membrane 6 is fixed onto the second soft shell 22, the lens membrane 6 is located at a notch 212 of the second hard shell 21, and the first hard shell 11 and the second soft shell 22 are snap-fitted together.

It can be understood that for the arrangement, the first hard shell 11 and the second hard shell 21 are both made from PC, and the first soft shell 12 and the second soft shell 22 are both made from TPU; the first hard shell 11 and the second hard shell 21 are used as supporting frameworks of the middle shell 1 and the back cover 2, respectively, and the first soft shell 12 and the second soft shell 22 are used as cushioning rubber coating for the middle shell 1 and the back cover 2, respectively, such that the middle shell 1 and the back cover 2 have good protective performance. The membrane 4 is fixed onto an inner side wall of the middle shell 1, such that the membrane 4 can be well adapted to the side touch-sensitive button 102; and the middle shell 1 is provided with the screen membrane 5 on a screen side of the mobile phone 101, and the back cover 2 is provided with the lens membrane 6 on a rear camera lens side of the mobile phone 101, such that the housing 201 can have good waterproof performance.

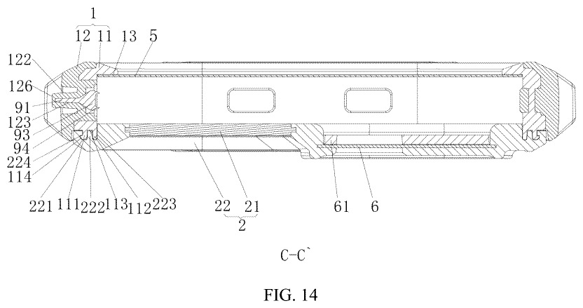

In order to guarantee the sealing between the middle shell 1 and the back cover 2, in this example, with reference to FIGS. 14-19, a circle of snap-fit blocks 111 and a circle of positioning blocks 112 are integrally formed on an end face of the first hard shell 11, a sealing slot 113 is formed between the snap-fit blocks 111 and the positioning blocks 112, and a snap-fit slot 221, a sealing ring 222, and a positioning slot 223 are integrally formed in a position near an edge of the second soft shell 22; and when the middle shell 1 and the back cover 2 are snap-fitted together, the snap-fit blocks 111 and the positioning blocks 112 of the first hard shell 11 are respectively snapped into the snap-fit slot 221 and the positioning slot 223 of the second soft shell 22, a snap-fit joint 114 of the snap-fit block 111 is snap-fitted on an inner step 224 in the snap-fit slot 221, and the sealing ring 222 of the second soft shell 22 is snap-fitted into the sealing slot 113 of the first hard shell 11, such that a sealing structure between the first hard shell 11 and second soft shell 22 is formed, and the middle shell 1 and the back cover 2 are assembled into a waterproof housing 201 through the sealing structure.

It can be understood that in the arrangement, the middle shell 1 and the back cover 2 can be snap-fitted together through the sealing structure to form a fully-enclosed waterproof protective case; the snap-fit blocks 111 of the first hard shell 11 and the snap-fit slot 221 of the second soft shell 22 form a first ring sealing structure, and the snap-fit joint 114 of the snap-fit blocks 111 can be snap-fitted on the inner step 224 in the snap-fit slot 221, ensuring stable snap-fitting connection between the first hard shell 11 and the second soft shell 22. The sealing slot 113 of the first hard shell 11 and the sealing ring 222 of the second soft shell 22 form a second ring sealing structure, and the flexible sealing ring 222 is capable of squeezing against an inner wall of the sealing slot 113, such that the sealing performance can be improved; and the positioning blocks 112 of the first hard shell 11 and the positioning slot 223 of the second soft shell 22 form a third ring sealing structure, and the hard positioning blocks 112 with a harder texture can fix the positioning slot 223, preventing the second soft shell 22 with a softer texture from sliding relative to the first hard shell 11, and destroying the sealing effect of the sealing structure.

It should be further noted that a connection between the middle shell 1 and the back cover 2 is arranged between the first hard shell 11 and the second soft shell 22, combination of the hard and soft material can ensure better sealing performance of the waterproof sealing structure. A flange 211 is formed on an edge of the second hard shell 21 in a protruding manner, and the arrangement of the flange 211 is conducive to strengthening a bonding strength between the second hard shell 21 and the second soft shell 22, preventing them from debonding.

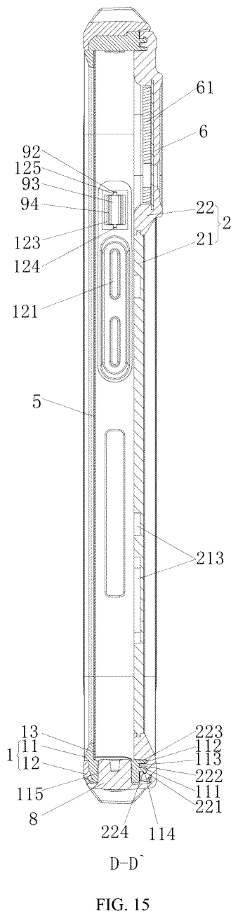

In order to waterproof and seal a USB charging port 103 of the mobile phone 101, in this example, with reference to FIGS. 15-19, the second soft shell 22 is integrally formed with a plug 8, the first hard shell 11 is provided with a charging port 115, and the plug 8 is detachably fitted with the charging port 115.

It can be understood that for the arrangement, the plug 8 is made of TPU material same as that of the second soft shell 22, which is soft and can be squeezed to block the charging port 115 of the first hard shell 11, ensuring that no water enters the USB charging port 103. When the mobile phone 101 needs to be inserted into a charging socket, the plug 8 can be removed. The plug 8 is connected to the second soft shell 22, and the plug 8 will not fall off the housing 201, such that the charging port 115 can be re-blocked by the plug 8 once charging is completed. The situation is a case where a charging plug really needs to be inserted and removed. When wireless charging is available, the first hard shell 11 does not need to be provided with the charging port 115 at the USB charging port 103, in which case, the plug 8 is not needed, either.

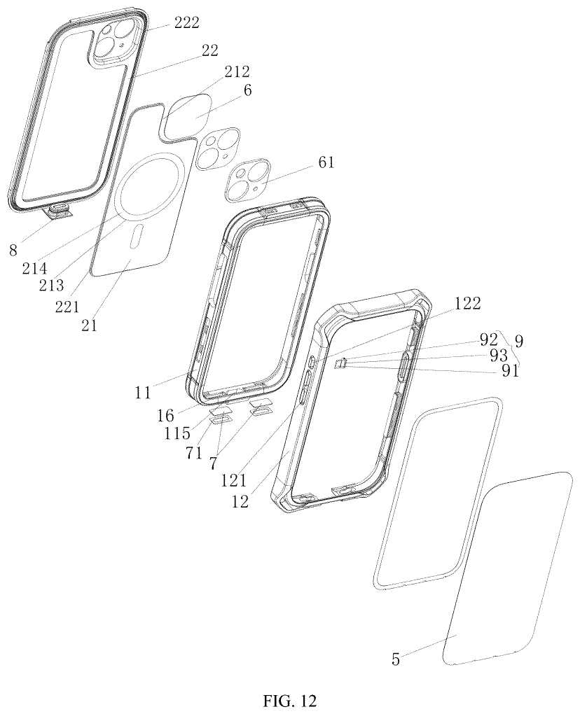

In order to ensure a speaker playback function of the mobile phone 101, in this example, with reference to FIG. 12, each of the first hard shell 11 and the first soft shell 12 is provided with a speaker hole 16, and a waterproof membrane 7 is fixedly arranged at the speaker hole 16 of the first hard shell 11.

It can be understood that for the arrangement, the waterproof membrane 7 is membrane material of 0.5 mm, which has minimal sound blocking property, thereby ensuring that the speaker playback function of the mobile phone 101 is not significantly affected. The waterproof membrane 7 is fixed onto an inner wall of the first hard shell 11 with waterproof glue 71, thereby ensuring good waterproof performance at the speaker holes 16.

It should be further noted that an inner side of the lens membrane 6 is fixed with a cushioning pad 61 with fixing glue. Both the lens membrane 6 and the screen membrane 5 are relatively thin, such that a buffer can be formed between the lens membrane 6 and a lens of the mobile phone 101 through the cushioning pad 61, the lens of the mobile phone 101 can be protected well, and the lens of the mobile phone 101 is prevented from being damaged. The first hard shell 11 and the first soft shell 12 are far higher than the screen membrane 5, such that they protect a screen of the mobile phone 101, preventing the screen from directly impacting an object.

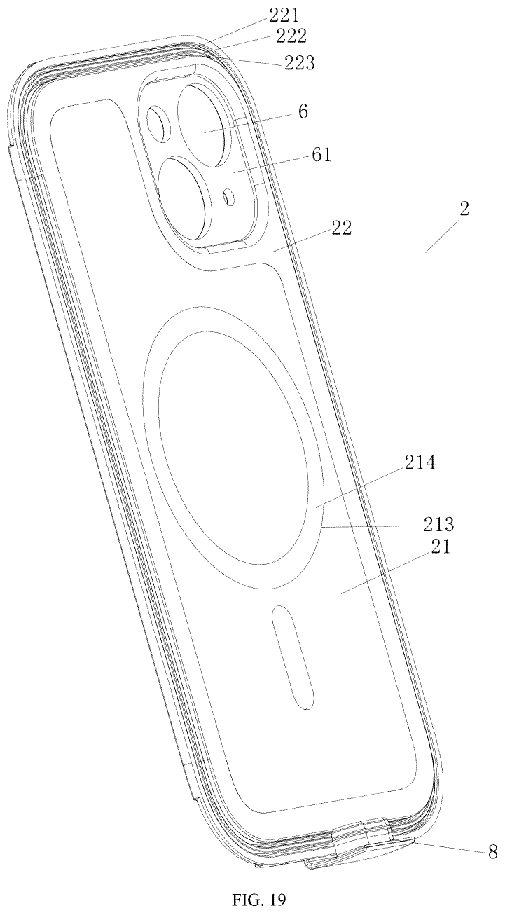

With reference to FIGS. 12 and 19, in order to achieve magnetic positioning between the mobile phone 101 and an external device, a shaped groove 213 is formed inside the second hard shell 21, and a magnetic attraction member 214 is installed in the shaped groove 213. The magnetic attraction member 214 facilitates magnetic alignment of the mobile phone 101 on a wireless charging panel or a magnetic bracket, such that a user can view videos on the mobile phone 101 conveniently.

In order to facilitate operation of the mute toggle key of the mobile phone 101, in this example, with reference to FIGS. 11-18, the first soft shell 12 is integrally formed with a press button 121 and a toggle button 122, the press button 121 acts on a volume button and a power button of the mobile phone 101, and the toggle button 122 acts on the mute toggle key of the mobile phone 101. A lever 9 is arranged inside the toggle button 122, the lever 9 includes a force-bearing end 91, a pivot 92, and a swinging end 93 connected in sequence, the force-bearing end 91 is embedded in a connecting groove 123 of the toggle button 122, the pivot 92 is installed inside a pivot hole 124 on an inner wall of the connecting groove 123, and the swinging end 93 is adapted to the mute toggle key of the mobile phone 101, such that the toggle button 122, driven by the force-bearing end 91, drives the swinging end 93 to swing around the pivot 92 in a thickness direction of the middle shell 1 to toggle the mute toggle key of the mobile phone 101.

It can be understood that through the arrangement, the press button 121 and the toggle button 122, formed by the first soft shell 12 wrapped over the first hard shell 11, make user of the softer characteristics of the first soft shell 12 to perform press and toggle operations. In addition, the first soft shell 12 can seal the openings on the first hard shell 11 by overmolding, ensuring the sealing of the middle shell 1. The lever 9 featuring harder texture can increase a strength of the toggle button 122, such that the toggle button 122 has sufficient strength to toggle the mute toggle key of the mobile phone 101.

In order to facilitate the control of the lever 9, in this example, with reference to FIG. 14, a part of the toggle button 122 that extends beyond an outer side wall of the first soft shell 12 is defined as a force-exerting end 126, and the force-bearing end 91 of the lever 9 extends into an interior of the force-exerting end 126.

It can be understood that through the arrangement, the force-exerting end 126 extends beyond the outer side wall of the first soft shell 12, such that the user can easily to locate a position of the toggle button 122 by touch or visual observation. In addition, the user can easily exert force of the finger onto the force-exerting end 126, and the force-bearing end 91 of the lever 9 is located at the force-exerting end 126, such that the user's finger can directly act on the force-bearing end 91 of the lever 9, ensuring that the user can accurately toggle the mute toggle key of the mobile phone 101.

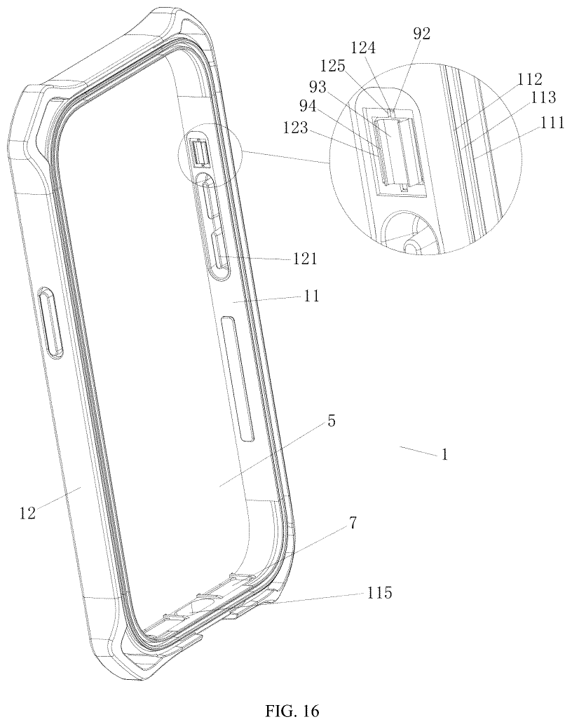

In order to enable the lever 9 to smoothly toggle the mute toggle key, in this example, with reference to FIG. 16, two toggle contacts 94 are arranged on an end face of the swinging end 93, and the two toggle contacts 94 are respectively located on two sides of the mute toggle key in the thickness direction of the middle shell 1.

It can be understood that for the arrangement, the lever 9 is a hardware component, and the swinging end 93 of the lever 9 is integrally formed with the two toggle contacts 94. When the lever 9 does not perform any action, the two toggle contacts 94 will not touch the mute toggle key; when the lever 9 swings up and down, one of the toggle contacts 94 will push the mute toggle key, such that the mute toggle key of the mobile phone 101 will be accurately toggled.

In order to install the lever 9 and prevent the lever 9 from detaching from the connecting groove 123 by itself, in this example, with reference to FIG. 16, the pivot hole 124 is provided with an opening 125, a width of the opening 125 is smaller than an inner diameter of the pivot hole 124, and the opening 125 of the pivot hole 124 and a notch of the connecting groove 123 are on a same plane.

It can be understood that through the arrangement, the lever 9 is installed inside the connecting groove 123 in an inserted manner, the force-bearing end 91 of the lever 9 is inserted into the connecting groove 123 and is in tight contact with an inner wall of the connecting groove 123, the pivot 92 of the lever 9 is snapped into the pivot hole 124 via the opening 125, and a narrowed opening 125 can prevent the pivot 92 from automatically detaching from pivot hole 124, thus ensuring that the lever 9 is firmly snapped into the connecting groove 123. When the toggle button 122 drives the force-bearing end 91 to swing up and down, the pivot 92 rotates relative to the pivot hole 124, and the swinging end 93 swings in an opposite direction relative to the force-bearing end 91, such that the mute toggle key of the mobile phone 101 is toggled up and down.

For the mobile communication device protective case in this example, a fully-enclosed waterproof protective case is formed by snapping the sealing structure between the middle shell 1 and the back cover 2 together, providing excellent waterproof performance. The toggle button 122 is integrally formed on the softer first soft shell 12, and the lever 9 with harder texture is arranged inside the toggle button 122, the waterproof sealing performance of the waterproof protective case at a mute toggle key area is guaranteed by the toggle button 122, and the mute toggle key of the mobile phone 101 can be accurately toggled by the lever 9, which is convenient for the user to make operation.

In the above examples, the soft plastic membrane 43 can specifically be a PET plastic membrane, a TPU plastic membrane, a PE plastic membrane, or a PVC plastic membrane.

In order to flexibly control the touch-sensitive buttons and the mute toggle key of the mobile phone 101 while providing protection and waterproofing for the mobile phone 101, the membrane 4 and the toggle button 122 are accordingly arranged on the housing 201. However, whether to arrange the membrane 4 and the toggle button 122 on the housing 201 depends on whether the mobile phone 101 is provided with the touch-sensitive buttons and the mute toggle key. When the mobile phone 101 is provided with either the touch-sensitive buttons or the mute toggle key, the housing 201 only needs to be provided with either the membrane 4 or the toggle button 122. When the mobile phone 101 is provided with both the touch-sensitive buttons and the mute toggle key, the housing 201 needs to be provided with both the membrane 4 and the toggle button 122.

The mobile communication device protective case in the accompanying drawings of the present disclosure includes both the semi-enclosed non-waterproof protective case and the fully-enclosed waterproof protective case, which aims to illustrate a specific relationship between the membrane 4 and the housing 201. With a concept of protecting the side touch-sensitive button 102 and the rear touch-sensitive button by the membrane 4, the housing 201 can adopt a semi-enclosed structure or a fully-enclosed structure, and the membrane 4 is applicable to both the semi-enclosed and fully-enclosed protective cases. For a fully-enclosed dustproof, waterproof, and shockproof protective case, the membrane 4 cannot only protect the side touch-sensitive button 102 and the rear touch-sensitive button, but also help the protective case in achieving a sealing effect at the side touch-sensitive button 102 and the rear touch-sensitive button, thereby forming a triple-proof mobile communication device protective case suitable for the mobile phone 101 having the side touch-sensitive button 102 or the rear touch-sensitive button.

The above description is not intended to limit the technical scope of the present disclosure. Any modifications, equivalent changes, or alterations made based on the technical essence of the present disclosure still fall within the scope of the technical solutions of the present disclosure.

What is claimed is:

1. A mobile communication device protective case, comprising a housing put on a mobile phone, the housing is provided with a button opening at a position adapted to a touch-sensitive button, the button opening is installed with a membrane, and the membrane comprises a fingerprint area located in a center and a fixed area surrounding the fingerprint area; and the fixed area is fixedly connected to the housing, the fingerprint area is exposed from the button opening, and an inner side surface of the fingerprint area is connected to the touch-sensitive button located at the button opening, such that a user's finger can be recognized by the touch-sensitive button via the fingerprint area of the membrane.

2. The mobile communication device protective case according to claim 1, wherein the housing is a waterproof housing.

3. The mobile communication device protective case according to claim 1, wherein the membrane is a soft plastic membrane, and a thickness of the soft plastic membrane in the fingerprint area ranges from 0.1 mm to 0.4 mm.

4. The mobile communication device protective case according to claim 1, wherein the membrane is a glass membrane, and the glass membrane comprises an explosion-proof membrane layer, a glass layer, and an oil-resistant layer arranged in sequence; the explosion-proof membrane layer is arranged on a side close to the touch-sensitive button, the oil-resistant layer is exposed from the button opening, and the oil-resistant layer is an anti-fingerprint oil coating sprayed and cured on a surface of the glass layer; and a thickness of the explosion-proof membrane layer is 0.08-0.12 mm, and a thickness of the glass layer is 0.18-0.22 mm.

5. The mobile communication device protective case according to claim 1, wherein an outer surface of the fixed area of the membrane is provided with a first adhesive layer, and the first adhesive layer is bonded and fixed onto an inner side wall of the housing.

6. The mobile communication device protective case according to claim 1, wherein the membrane is fixed to the inner side wall of the housing by ultrasonic welding in the fixed area.

7. The mobile communication device protective case according to claim 1, wherein the membrane is fixed to the inner side wall of the housing by overmolding in the fixed area.

8. The mobile communication device protective case according to claim 1, wherein a second adhesive layer capable of conducting electricity that is bonded and fixed onto the touch-sensitive button is arranged on the inner side surface of the fingerprint area of the membrane, and the second adhesive layer is provided with a peelable release layer before the housing is used.

9. The mobile communication device protective case according to claim 1, wherein the housing comprises a middle shell, and the membrane is arranged on the middle shell and is adapted to a side touch-sensitive button of the mobile phone.

10. The mobile communication device protective case according to claim 1, wherein the housing comprises a back cover, and the membrane is arranged on the back cover and is adapted to a rear touch-sensitive button of the mobile phone.

11. The mobile communication device protective case according to claim 1, wherein the housing comprises the middle shell and the back cover that are snap-fitted together; the middle shell comprises a first hard shell and a first soft shell, the first soft shell is plastically wrapped around an outer side of the first hard shell, and a first step surface on an inner side wall of the first hard shell is fixedly provided with a screen membrane; and the back cover comprises a second hard shell, a second soft shell, and a lens membrane, the second hard shell is plastically wrapped and fixed in the second soft shell, the lens membrane is fixed onto the second soft shell, the lens membrane is located at a notch of the second hard shell, and the first hard shell and the second soft shell are snap-fitted together.

12. The mobile communication device protective case according to claim 11, wherein a circle of snap-fit blocks and a circle of positioning blocks are integrally formed on an end face of the first hard shell, a sealing slot is formed between the snap-fit blocks and the positioning blocks, and a snap-fit slot, a sealing ring, and a positioning slot are integrally formed in a position near an edge of the second soft shell; and when the middle shell and the back cover are snap-fitted together, the snap-fit blocks and the positioning blocks of the first hard shell are respectively snapped into the snap-fit slot and the positioning slot of the second soft shell, a snap-fit joint of the snap-fit block is snap-fitted on an inner step in the snap-fit slot, and the sealing ring of the second soft shell is snap-fitted into the sealing slot of the first hard shell, such that a sealing structure between the first hard shell and the second soft shell is formed, and the middle shell and the back cover are assembled into a waterproof housing through the sealing structure.

13. The mobile communication device protective case according to claim 11, wherein the first soft shell is integrally formed with a connector, the connector is snap-fitted with a plug, the first hard shell is provided with a charging port, and the plug is detachably fitted with the charging port.

14. The mobile communication device protective case according to claim 11, wherein the second soft shell is integrally formed with a plug, the first hard shell is provided with a charging port, and the plug is detachably fitted with the charging port.

15. The mobile communication device protective case according to claim 11, wherein the first soft shell is integrally formed with a toggle button, a lever is arranged inside the toggle button, the lever comprises a force-bearing end, a pivot, and a swinging end connected in sequence, the force-bearing end is embedded in a connecting groove of the toggle button, the pivot is installed inside a pivot hole on an inner wall of the connecting groove, and the swinging end is adapted to a mute toggle key of the mobile phone, such that the toggle button, driven by the force-bearing end, drives the swinging end to swing around the pivot in a thickness direction of the middle shell to toggle the mute toggle key of the mobile phone.

16. The mobile communication device protective case according to claim 15, wherein a part of the toggle button that extends beyond an outer side wall of the first soft shell is defined as a force-exerting end, and the force-bearing end of the lever extends into an interior of the force-exerting end.

17. The mobile communication device protective case according to claim 15, wherein two toggle contacts are arranged on an end face of the swinging end, and the two toggle contacts are respectively located on two sides of the mute toggle key in the thickness direction of the middle shell.

18. The mobile communication device protective case according to claim 15, wherein the pivot hole is provided with an opening, a width of the opening is smaller than an inner diameter of the pivot hole, and the opening of the pivot hole and a notch of the connecting groove are on a same plane.

19. The mobile communication device protective case according to claim 11, wherein each of the first hard shell and the first soft shell is provided with a speaker hole, and a waterproof membrane is fixedly arranged at the speaker hole of the first hard shell.
